(19) United States
(12) Patent Application Publication
(10) Pub. No.: US 2026/0019779 A1
(43) Pub. Date: Jan. 15, 2026

(54) OBJECT PRIORITIZATION, SELECTION, AND ORDERING FOR SENSOR SHARING SERVICE

(71) Applicant: QUALCOMM Incorporated, San Diego, CA (US)

(72) Inventors: Seung Ryul YANG, San Diego, CA (US); Vincent Douglas PARK, Alexandria, VA (US)

(21) Appl. No.: 19/189,781

(22) Filed: Apr. 25, 2025

Related U.S. Application Data
(60) Provisional application No. 63/669,100, filed on Jul. 9, 2024.

(51) Int. Cl. H04W 4/38; H04W 4/12; H04W 64/00

(52) U.S. Cl. CPC H04W 4/38; H04W 4/12; H04W 64/00

(57) ABSTRACT

Disclosed are techniques for wireless communication. In an aspect, a processing device may obtain one or more detected object information sets corresponding to one or more detected objects. The processing device may perform an object prioritization on the one or more sets of detection information based on a prioritization mechanism to obtain a prioritized order of the one or more sets of detection information. The processing device may add a subset of the one or more detected object information sets to a message associated with a transmission interval, the subset being selected based on a maximum number of detected object information sets and the prioritized order of the one or more sets of detection information. The processing device may transmit the message within the transmission interval.

### CROSS-REFERENCE TO RELATED APPLICATIONS

The present application for patent claims the benefit of U.S. Provisional Application No. 63/669,100, entitled “OBJECT PRIORITIZATION, SELECTION, AND ORDERING FOR SENSOR SHARING SERVICE,” filed Jul. 9, 2024, assigned to the assignee hereof, and expressly incorporated herein by reference in its entirety.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a processing device includes obtaining one or more detected object information sets corresponding to one or more detected objects, each set of the one or more detected object information sets corresponding to a corresponding one of the one or more detected objects and associated object information; performing a first object prioritization on the one or more sets of detection information based on a first prioritization mechanism to obtain a first prioritized order of the one or more sets of detection information; adding a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and transmitting the message within the transmission interval.

In an aspect, a processing device includes one or more memories; one or more transceivers; and one or more processors communicatively coupled to the one or more memories and the one or more transceivers, the one or more processors, either alone or in combination, configured to: obtain one or more detected object information sets corresponding to one or more detected objects, each set of the one or more detected object information sets corresponding to a corresponding one of the one or more detected objects and associated object information; perform a first object prioritization on the one or more sets of detection information based on a first prioritization mechanism to obtain a first prioritized order of the one or more sets of detection information; add a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and transmit, via the one or more transceivers, the message within the transmission interval.

In an aspect, a processing device includes means for obtaining one or more detected object information sets corresponding to one or more detected objects, each set of the one or more detected object information sets corresponding to a corresponding one of the one or more detected objects and associated object information; means for performing a first object prioritization on the one or more sets of detection information based on a first prioritization mechanism to obtain a first prioritized order of the one or more sets of detection information; means for adding a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and means for transmitting the message within the transmission interval.

In an aspect, a non-transitory computer-readable medium stores computer-executable instructions that, when executed by a processing device, cause the processing device to: obtain one or more detected object information sets corresponding to one or more detected objects, each set of the one or more detected object information sets corresponding to a corresponding one of the one or more detected objects and associated object information; perform a first object prioritization on the one or more sets of detection information based on a first prioritization mechanism to obtain a first prioritized order of the one or more sets of detection information; add a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and transmit the message within the transmission interval.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIG. 3 illustrates several example components that may be incorporated into a processing device, according to aspects of the disclosure.

FIG. 4A and FIG. 4B depict sensing sharing scenarios, according to aspects of the disclosure.

FIG. 5A and FIG. 5B illustrate example use cases related to sensor sharing functionalities, according to aspects of the disclosure.

FIG. 6 illustrates possible approaches to address the technology issues related to sensor sharing functionalities, according to aspects of the disclosure.

FIG. 7 depicts an example scenario in which existing object inclusion rules may be deficient, according to aspects disclosure.

FIG. 8 depicts an example scenario in which existing message assembly rules may be deficient, according to aspects disclosure.

FIG. 9 illustrates various example operations that may be executed to transmit a sensor-sharing message, according to aspects of the disclosure.

FIG. 10 shows example areas of risk, according to aspects of the disclosure.

FIG. 11 shows another set of examples of areas of risk, according to aspects of the disclosure.

FIG. 12 illustrates an example scenario in which objects may be prioritized, according to aspects of the disclosure.

FIG. 13 illustrates another example scenario in which objects may be prioritized, according to aspects of the disclosure.

FIG. 14 shows an example of a sensor-sharing message structure, according to aspects of the disclosure.

FIG. 15 shows an example of a sensor-sharing message structure, according to aspects of the disclosure.

FIG. 16 shows an example of a sensor-sharing message structure, according to aspects of the disclosure.

FIG. 17 shows example operations that may be undertaken to generate and transmit a sensing message, according to aspects of the disclosure.

FIG. 18 through FIG. 21 show variations of the example operations that may be undertaken to generate and transmit a sensing message, according to aspects of the disclosure.

FIG. 22 and FIG. 23 show example sensor-sharing message structures, according to aspects of the disclosure.

FIG. 24 illustrates an example method of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

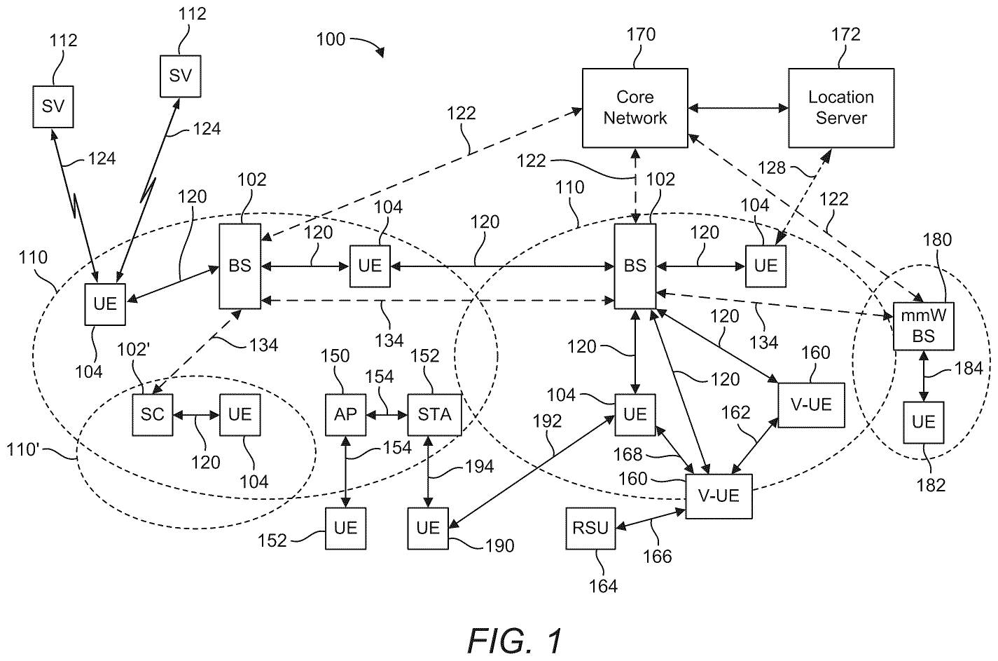

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STA s 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SV s) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDM A systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

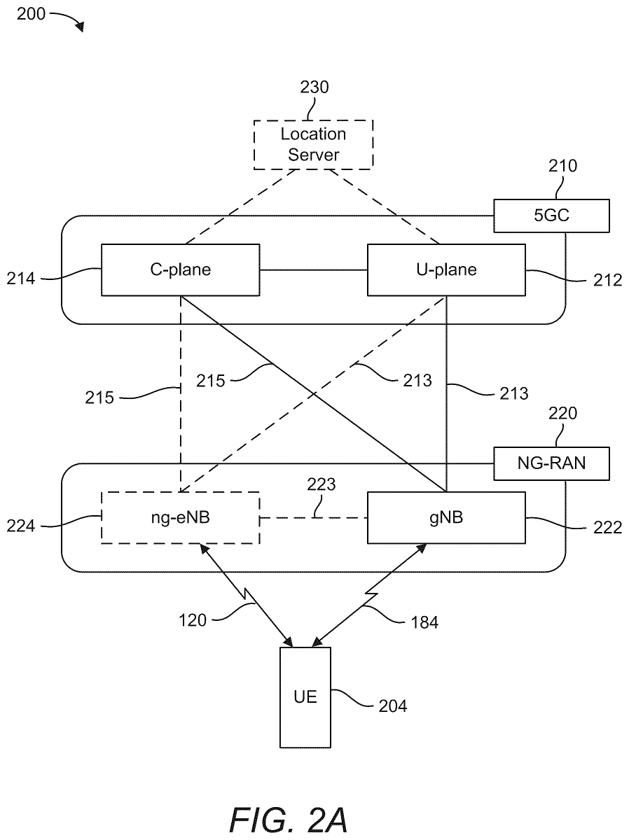

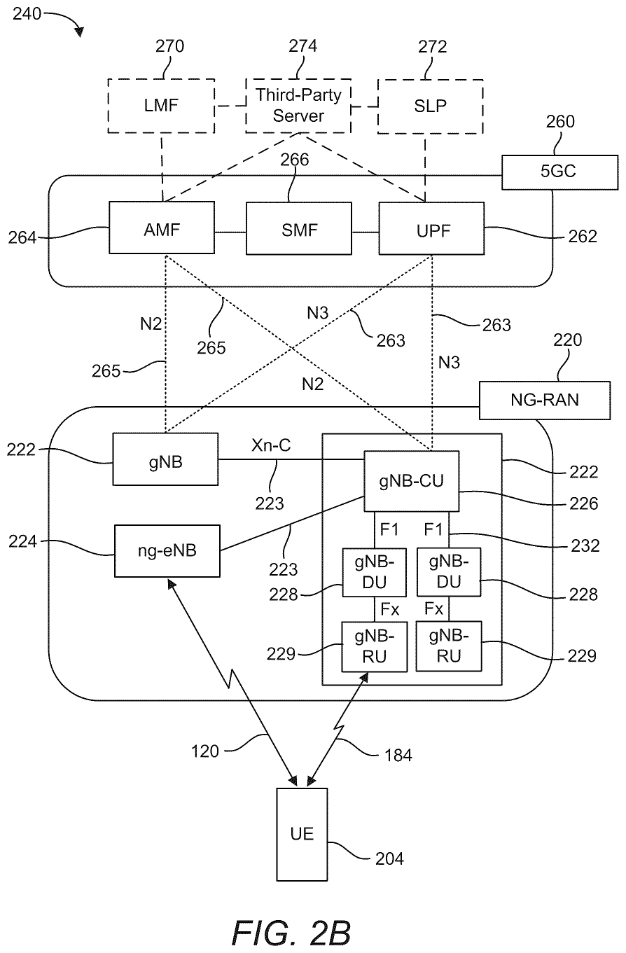

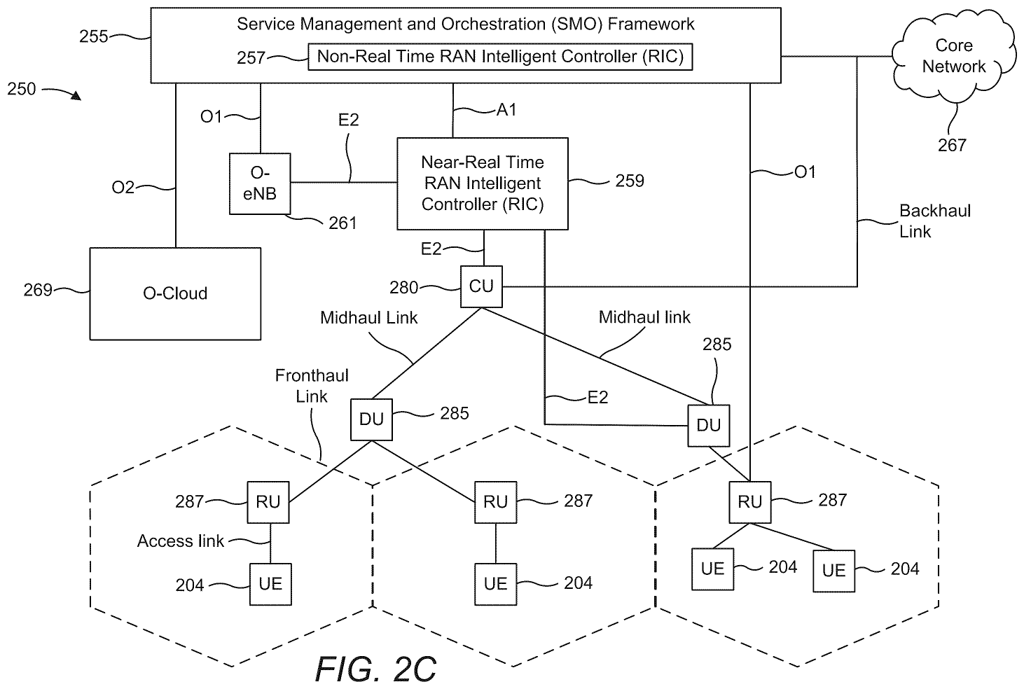

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IA B) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

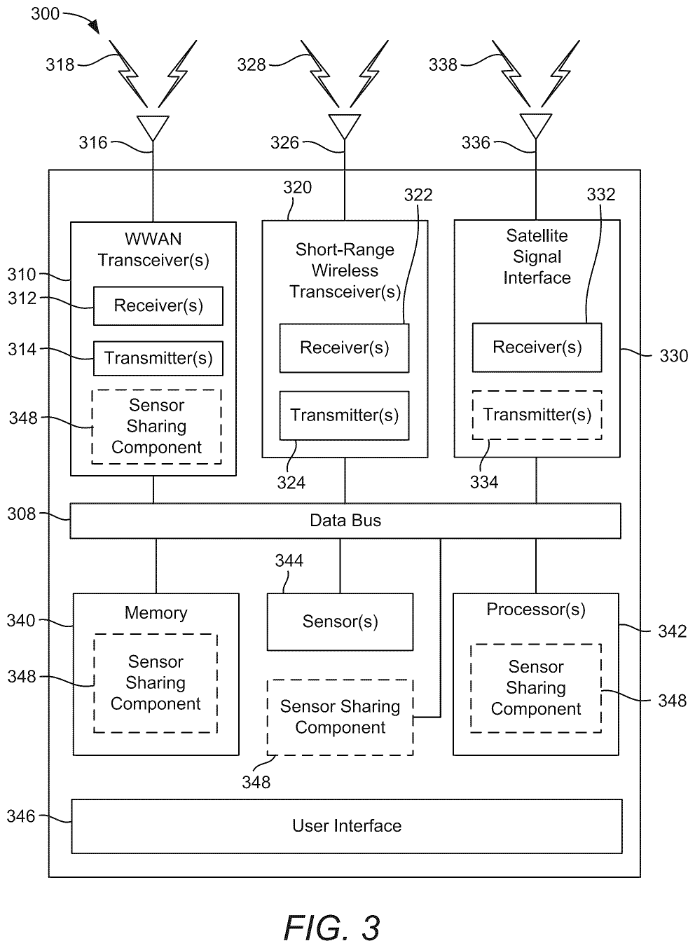

FIG. 3 illustrates several example components (represented by corresponding blocks) that may be incorporated into a processing device 300 (which may correspond to any of the UEs or RSUs described herein, or an infrastructure system that is capable of transmitting based on sidelink communications or V2X communications). It will be appreciated that these components may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The processing device 300 includes one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The processing device 300 also includes, at least in some cases, one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, BLUETOOTH®, ZIGBEE®, Z-WAVE®, PC5, dedicated short-range communications (DSRC), wireless access for vehicular environments (WAVE), near-field communication (NFC), ultra-wideband (UW B), etc.) over a wireless communication medium of interest. The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The processing device 300 also includes, at least in some cases, a satellite signal interface 330, which includes one or more satellite signal receivers 332 and may optionally include one or more satellite signal transmitters 334. The one or more satellite signal receivers 332 may be connected to one or more antennas 336 and may provide means for receiving and/or measuring satellite positioning/communication signals 338. Where the one or more satellite signal receivers 332 include a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 332 include a non-terrestrial network (NTN) receiver, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine locations of the processing device 300 using measurements obtained by any suitable satellite positioning system algorithm.

The optional satellite signal transmitter(s) 334, when present, may be connected to the one or more antennas 336 and may provide means for transmitting satellite positioning/communication signals 338. Where the one or more satellite signal transmitters 334 include an NTN transmitter, the satellite positioning/communication signals 338 may be communication signals (e.g., carrying control and/or user data) originating from a 5G network. The one or more satellite signal transmitters 334 may comprise any suitable hardware and/or software for transmitting satellite positioning/communication signals 338. The one or more satellite signal transmitters 334 may request information and operations as appropriate from the other systems.

A transceiver may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., processing device 300) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., processing device 300) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., processing device 300) and a base station will generally relate to signaling via a wireless transceiver.

The processing device 300 also includes other components that may be used in conjunction with the operations as disclosed herein. The processing device 300 includes one or more processors 342 for providing functionality relating to, for example, wireless communication, and for providing other processing functionality. The one or more processors 342 may therefore provide means for processing, such as means for determining, means for calculating, means for receiving, means for transmitting, means for indicating, etc. In an aspect, the one or more processors 342 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The processing device 300 includes memory circuitry implementing memory 340 (e.g., each including a memory device) for maintaining information (e.g., information indicative of reserved resources, thresholds, parameters, and so on). The memory 340 may therefore provide means for storing, means for retrieving, means for maintaining, etc. In some cases, the processing device 300 may include a sensor sharing component 348. The sensor sharing component 348 may be hardware circuits that are part of or coupled to the one or more processors 342 that, when executed, cause the processing device 300 to perform the functionality described herein. In other aspects, the sensor sharing component 348 may be external to the processors 342 (e.g., part of a modem processing system, integrated with another processing system, etc.). Alternatively, the sensor sharing component 348 may be a memory module stored in the memory 340 that, when executed by the one or more processors 342 (or a modem processing system, another processing system, etc.), cause the processing device 300 to perform the functionality described herein. FIG. 3 illustrates possible locations of the sensor sharing component 348, which may be, for example, part of the one or more WWAN transceivers 310, the memory 340, the one or more processors 342, or any combination thereof, or may be a standalone component.

The processing device 300 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems. Note that at least the accelerometer and gyroscope may be referred to as “inertial” sensors.

The various components of the processing device 300 may be communicatively coupled to each other over a data bus 308. In an aspect, the data bus 308 may form, or be part of, a communication interface of the processing device 300.

In addition, the processing device 300 includes a user interface 346 providing means for providing indications (e.g., audible and/or visual indications) to a user and/or for receiving user input (e.g., upon user actuation of a sensing device such a keypad, a touch screen, a microphone, and so on).

For convenience, the processing device 300 is shown in FIG. 3 as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For example, a particular implementation of processing device 300 may omit the WWAN transceiver(s) 310 (e.g., a wearable device or tablet computer or PC or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. For brevity, illustration of the various alternative configurations is not provided herein, but would be readily understandable to one skilled in the art.

The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the processing device 300 (e.g., by execution of appropriate code and/or by appropriate configuration of processor components). For simplicity, various operations, acts, and/or functions are described herein as being performed “by a processing device.” However, as will be appreciated, such operations, acts, and/or functions may actually be performed by specific components or combinations of components of the processing device 300, such as the one or more processors 342, the one or more transceivers 310 and 320, the memory 340, the sensor sharing component 348, etc.

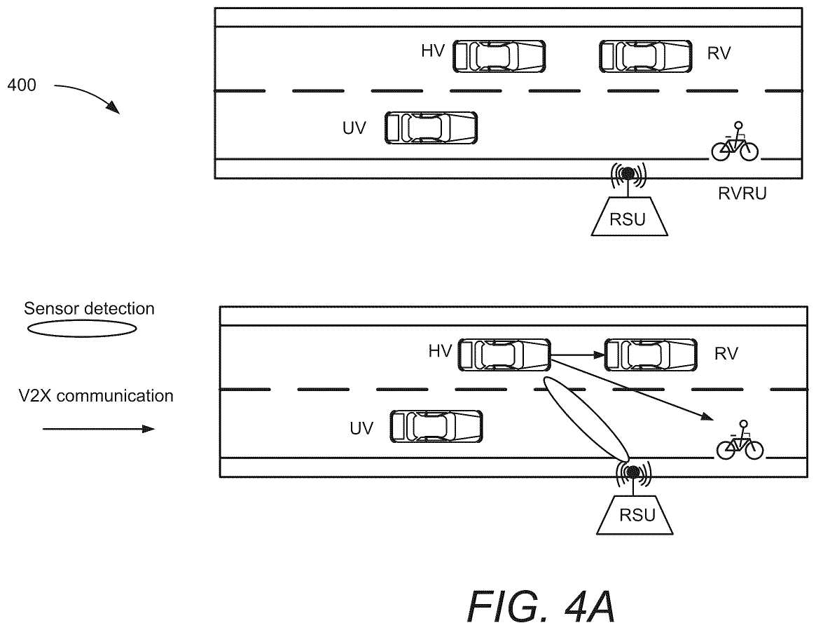

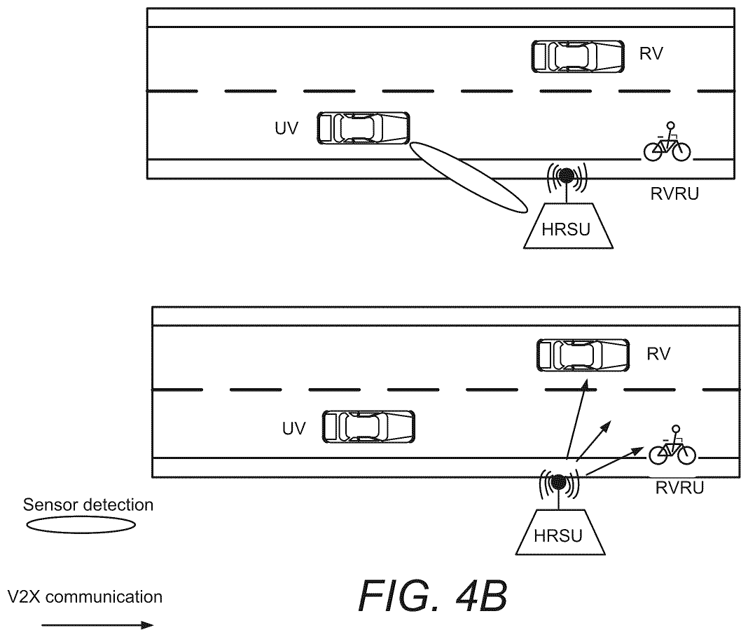

FIG. 4A and FIG. 4B depict sensor sharing scenarios, according to aspects of the disclosure. “Sensor sharing” is a process where multiple systems—such as vehicles, robots, drones, or infrastructure—exchange sensor data with each other to enhance their perception and understanding of the environment. There are various standards that govern the implementation of systems having sensor sharing. One standard is the Sensor Data Sharing Mechanism (SDSM) standard defined by the Society of Automotive Engineers (SAE) (SAE J 3224). Other standards include the Cooperative Perception Message (CPM) standard defined by ETSI (European Telecommunications Standards Institute). Another standard is the sensor sharing and cooperative perception (SSM) standard, which is primarily used in China. The sensor-sharing messages of SDSM (SAE J 3224), CPM (ETSI), and SSM (China) are designed for use by both vehicles (OBUs) and infrastructures (RSUs).

In FIG. 4A, there are different types of vehicles (HB, UV, and RV) that are identified and classified based on their roles in the data-sharing process. HVs are host vehicles that share data and use local sensor data and data from other sources to build their perception of the environment. RVs are remote vehicles that transmit their sensor data or object detection to other vehicles. UVs are unknown vehicles that are observed or detected but do not directly participate in the sharing.

FIG. 4A depicts a sensing scenario 400 that employs a roadside remote-sensing unit (RRSU). An RSSU is a stationary sensing and communication unit deployed along the roadside (e.g., on traffic lights, poles, or gantries) that 1) collects sensor data; 2) detects objects in its surroundings (e.g., pedestrians, cyclists, vehicles), and sends Cooperative Perception Messages (CPMs) or Sensor Data Sharing Messages (SDSMs) to nearby vehicles.

FIG. 4B depicts a sensing scenario 402 employing a host sensing reporting unit (HSRU). An HSRU is a component that may be located in a vehicle (usually the host vehicle) that is responsible for 1) sensing the environment using onboard sensors (camera, LiDAR, radar, etc.), 2) detecting and tracking objects, 3) generating perception data (e.g., object lists), and 4) reporting that data to other entities (vehicles, infrastructure) via standardized messages.

Vehicle-to-everything (V2X)-capable road users (vehicle, VRUs, etc.) can disseminate information about themselves (type, size, position, kinematics, etc.) to other road users via V2X communication. Sensor sharing is used for the dissemination of information about detected objects by vehicles and RSUs (via their sensors) over V2X to other V2X entities. The shared data can include descriptions of the characteristics of the detected objects (e.g., size, location, and motion state) and may be shared through transmission of sensor-sharing messages. This dissemination increases awareness among the road users, and can be beneficial for road safety and traffic efficiency. However, not all road users have V2X-capability and some may lack the ability to send or receive the information needed to enhance road safety and traffic efficiency.

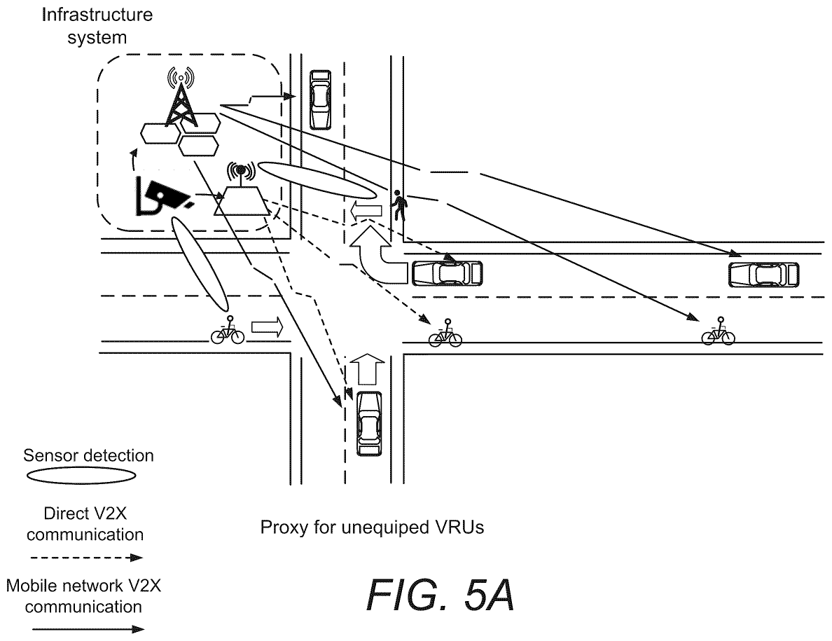

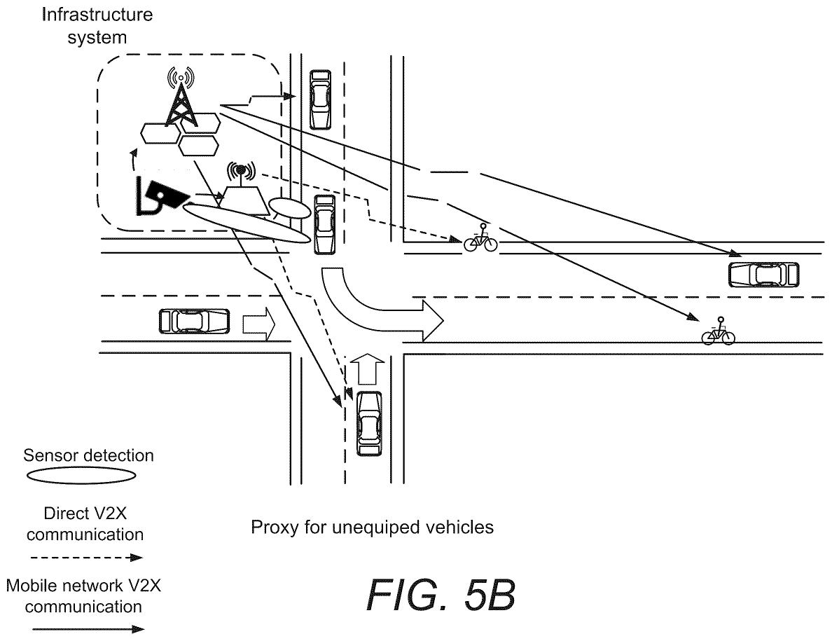

FIG. 5A and FIG. 5B illustrate example use cases related to sensor sharing functionalities, according to aspects of the disclosure. In some aspects, the processing devices described in various examples correspond to the devices of the infrastructure system shown in FIG. 5A and FIG. 5B. In various examples, the system may employ sensors onboard a vehicle or an RSU. Here, the scenario 500 shown in FIG. 5A is based on sensing by proxy for unequipped VRUs. The scenario 502 shown in FIG. 5B is based on sensing by proxy for unequipped vehicles.

There are limits on the number of objects a sensor-sharing message can convey. There are several reasons contributing to such limitations. For example, the size of a sensor-sharing message may be limited by channel capacity thereby limiting the number of objects and corresponding information that may be conveyed in the sensor-sharing message. Such limitations are imposed when there is a need to use a common channel to support a plurality of messages for multiple safety services. Sensor-sharing messages may also be subject to 1) packet size limitation in protocols (usually the PHY/MAC protocols) and 2) limitations from the implementation (e.g., due to the processing burden in senders).

The foregoing limitations may be problematic when there are more detected objects than the limitations allow. As such, there is a need to limit and prioritize which objects of the detected objects should have their information conveyed in a sensor-sharing message.

In some aspects, bandwidth or frequency resources may be allocated for safety-related messages. However, the sensor-sharing functionalities may not occupy the allocated resources without limitations, as the allocated resources may be used for other safety services. As such, there may be a limit as to how many messages may be used for sensor sharing functionalities during a transmission period or how many detected objects may be shared (i.e., reported) during a transmission period.

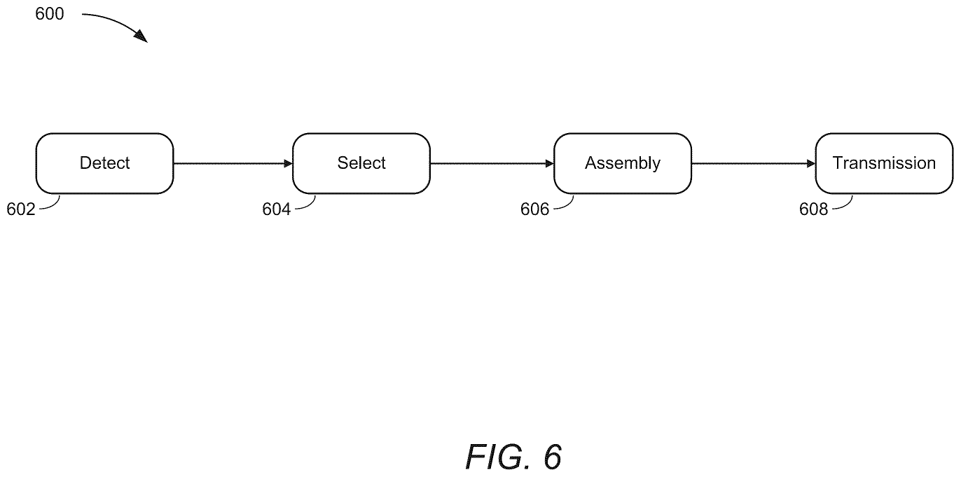

FIG. 6 illustrates possible approaches to address the technology issues related to sensor-sharing functionalities, according to aspects of the disclosure. In some aspects, the transmission may be based on a transmission interval. In some aspects, the transmission interval may correspond to periodically transmitting sensor-sharing messages or aperiodically transmitting sensor-sharing messages based on triggering events. In some aspects, the transmission interval may range from 10 to 200 milliseconds (ms). In some aspects, the inclusion interval may correspond to an object that has been previously detected but has not been reported for a given period of time.

In FIG. 6, object detection occurs at operation 602. In certain scenarios, the number of objects may exceed the capabilities of the system. Accordingly, object selection occurs at operation 604. In an aspect, operation 602 includes the application of an “Object inclusion rule” (e.g., determining whether or not characteristics of an object are to be included in CPM(s)). The object inclusion rule may be based on 1) whether the object is newly detected, 2) whether an inclusion interval has elapsed (e.g., VRU: 500 ms, Vehicle: 1 s), 3) whether the object is a highly dynamic vehicle, etc. In certain scenarios, object selection may be subject to custom implementations.

Operation 604 is conventionally limited to a binary prioritization that does not assign the ordered priorities to the detected objects. Even with the selection operations performed at operation 604, the number of detected objects may still exceed the capacity of the system.

The sensing scenario may also involve an assembly operation 606. In the assembly operation 604, CPM(s) are assembled based on the ordered assembly priority to fit the packet size limitation in protocols. It should be noted that all selected objects are transmitted in a transmission interval (by one or more CPMs). The assembling operations may be based on prioritizing the objects using an object utility function/mechanism (quality, dynamics, interval). Additionally, or in the alternative, the assembling operations may be based on perception regions. Here, the CPMs are transmitted at operation 608.

Certain aspects of the disclosure are implemented with a recognition that there are various deficiencies associated with existing object selection and assembling operations. For example, existing object inclusion rules are solely used to determine whether a detected object is to be included in CPM(s) or not. The selection is based on a limited (binary) prioritization which does not assign an ordered priorities to the objects. The existing object inclusion rules are not designed for a CPM to fit to a certain packet size or convey information for a certain number of objects.

Certain aspects of the disclosure are also implemented with a recognition that there are certain deficiencies associated with the existing assembly operation. In an aspect, the assembly operation provides a prioritization that assigns the ordered priorities to the objects. However, it assumes that all the selected objects are to be transmitted during a reporting interval no matter what priorities are assigned to the objects. The assembly priority does not take into consideration that object information may not be transmitted for some of the detected objects. The approach (sending all selected objects in an interval via multiple messages) may not be appropriate given a limited channel capacity, where there is a need to use a common channel to support a plurality of messages for multiple safety services. Certain aspects of the disclosure are implemented with a recognition that transmitting one message in an interval may be desirable so that the bandwidth usage of the sensor-sharing service is properly bound without unlimitedly increasing with the number of detected objects. The existing object inclusion rule and assembly priority operations are not appropriate because they are not designed for the approach.

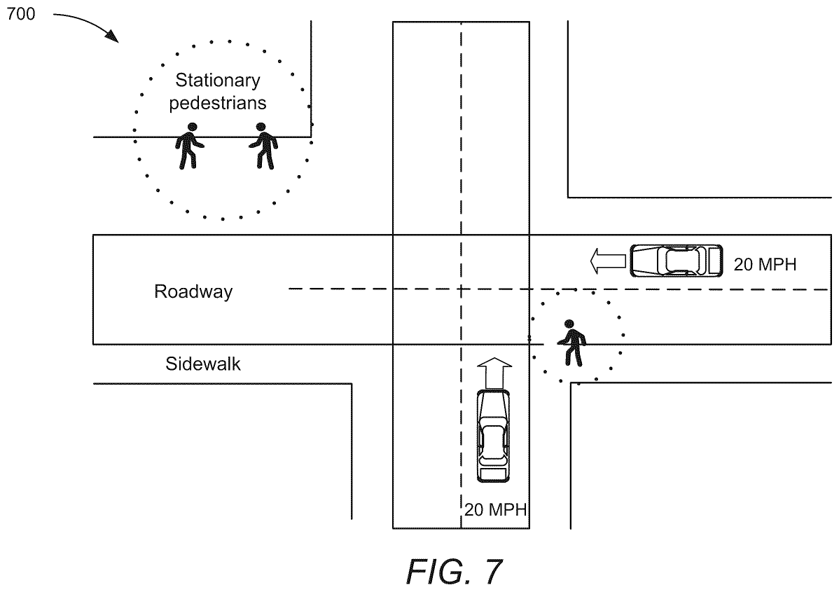

FIG. 7 depicts an example scenario 700 in which existing object inclusion rules may be deficient, according to aspects disclosure. Certain aspects of the disclosure are discussed discussed in the context of sensor sharing at intersections. However, the disclosed teachings are not necessarily limited to such scenarios.

With existing object inclusion rules, prioritization is based on object type, dynamics, and whether the object is a newly detected object. The existing object inclusion rule is a limited (binary) prioritization that does not assign ordered priorities to the objects. The rule assigns priorities based on a prioritization scheme in which a detected object=dynamic vehicles>VRU>less dynamic vehicles. The existing object inclusion rule may be acceptable to approaches in which information regarding all detected objects is sent. However, it is not acceptable for scenarios in which information regarding only a limited number of objects are to be sent.

At intersections, where most accidents occur in a specific area, the existing object inclusion rule does not properly reflect the urgency/importance of the object. For example, if information on only three objects are allowed in a sensor-sharing message, the prioritization based on object type in FIG. 7 will only select the pedestrians (assuming other factors are same), and this selection will be repeated in subsequent intervals. Certain aspects of the disclosure recognize that a preferred approach would include messaging relating to riskier objects regardless of the type of objects.

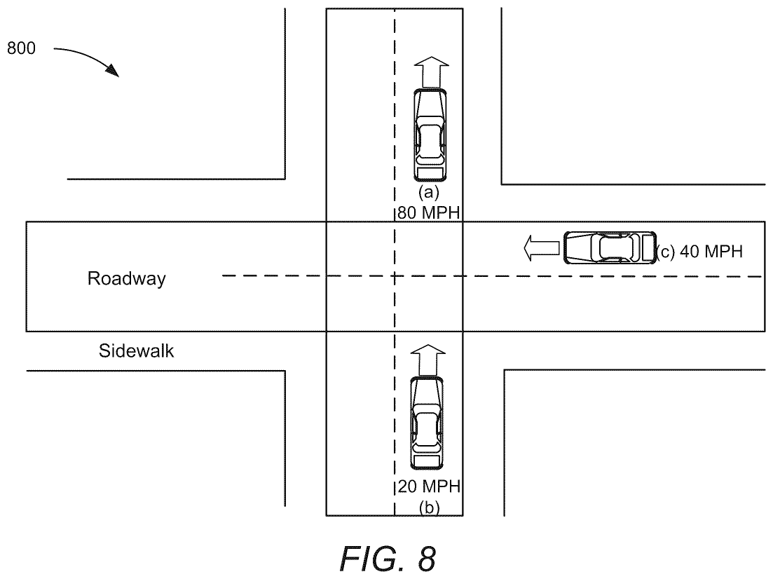

FIG. 8 depicts an example scenario 800 in which existing message assembly rules may be deficient, according to aspects disclosure. In existing approaches, prioritization is based on object utility function. The function is based on “object perception quality,” “the object dynamics (position/speed/heading changes),” and the “elapsed interval.” The object utility function may be acceptable in scenarios in which messages for all detected objects are to be sent. However, it is not to acceptable for scenarios in which only a limited number of objects (e.g., less than all detected objects) are to be sent.

Again, at intersections, where accidents happen primarily in a specific area, the object utility function does not properly reflect the urgency/importance of the object. For example, if only one object can be added to the sensor-sharing message in scenario 800, the object utility function will select object (a) (assuming other factors are same) because it is the fastest moving object. The selection of object (a) will occur even though it is outbound and may be less dangerous with respect to the intersection than other objects. Certain aspects of the disclosure recognize that a preferred approach would be to include objects associated with a higher risk rather than objects simply having more dynamics.

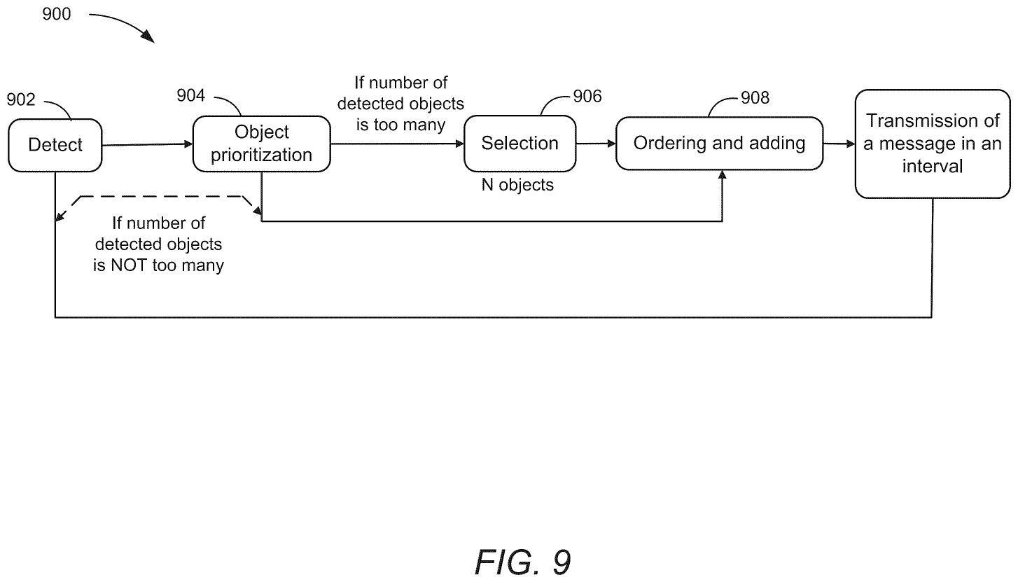

FIG. 9 illustrates example operations 900 that may be executed pursuant to transmitting a sensor-sharing message, according to aspects of the disclosure. In some aspects, the prioritization mechanism may be selected based on first knowing the type of receiver to which the message is targeted. In some aspects, different types of target receivers (e.g., cars, trucks, motorcycles, cyclists, or pedestrians) may be associated with different risk factor evaluations. In some aspects, the prioritization mechanism may also consider a type of lane the detected object is travelling (e.g., turning lane, through lane, bike lane, etc.).

In FIG. 9, it is assumed that the maximum packet size (limited here to object information associated with a maximum number of objects, N) has been based on the protocols, network congestion, environmental situation, and/or the limitation of the implementation. Here, objects are detected at operation 902. If the number of objects is not too many (e.g., lower than a threshold number of objects), the prioritization and ordering of the objects need not be performed. However, in such instances, prioritization and ordering can be beneficial to receivers having a limited capability to entirely decode a received message.

If the number of detected objects is above a threshold number, object prioritization may take place at operation 904. At operation 906, the detected objects are subject to a selection operation 906 (e.g., N objects are selected in FIG. 9). The selected objects are naturally ordered by the prioritization at the ordering and adding operation 908. When the selected objects are incorporated in a sensor sharing message, the message may indicate 1) which prioritization mechanism has been used for object prioritization, 2) how the selected objects have been assessed by the prioritization mechanism, and 3) any useful supplementary information with the prioritization mechanism. In an aspect, such information may be indicated in message fields so that a receiver has knowledge of the manner associated with the manner in which the object prioritized. In an aspect, one sensor sharing message may be sent in a given transmission interval. Such interval operations are appropriate to congested network situations.

The object prioritization operation 904 may be implemented based on various criterion. In an aspect, the prioritization may be based on the distance that an object is from an area of risk (e.g., DRA (Distance to Risky Area)). In an aspect, a higher priority may be given to an object that is located closer to the area of risk. In an aspect, the prioritization may be based on a Time to Risky Area (TRA) assessment. In a TRA assessment, a higher priority may be assigned to an object that is expected to have a shorter time before it enters the area of risk. In an aspect, the expected time can be calculated based on the currently detected speed and heading of the object (with addition of some uncertainty). Expected time can also be calculated assuming that an object is moving at its currently detected acceleration and heading (with addition of some uncertainty).

In an aspect, object prioritization may be based on a collision estimate (e.g., Time to Collision (TTC)). Such TTC prioritization may assign a priority to an object that is expected to have a shorter time to collision with other objects. In an aspect, the TTC may be calculated based on the kinematics and positions of all detected and known (by any means) objects at the intersection (with addition of some uncertainty).

In accordance with aspects of the disclosure, a determination of whether an area is risky and subject to the prioritization criterion may be determined by the sensing infrastructure. In an aspect, the infrastructure can determine that an area is an area of risk based on many factors (e.g., the geometry, topology, work zone, hidden area, road pavement condition, weather condition, time (day, night, sunglow), historical crash data, etc.).

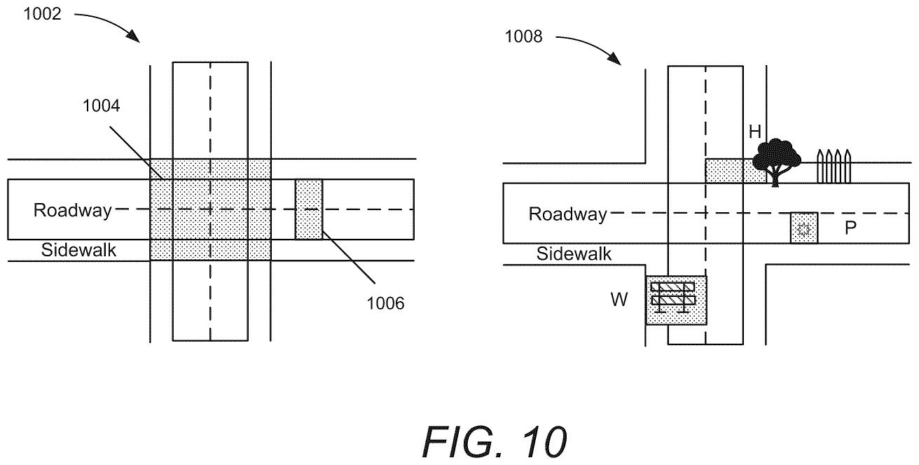

FIG. 10 shows example areas of risk, according to aspects of the disclosure. In scenario 1002, the designation of risky areas 1004 and 1006 may be based on the historical crash data. In scenario 1008, a work zone (W), a hidden area (H), and a road pavement condition (P) have been designated as risky areas.

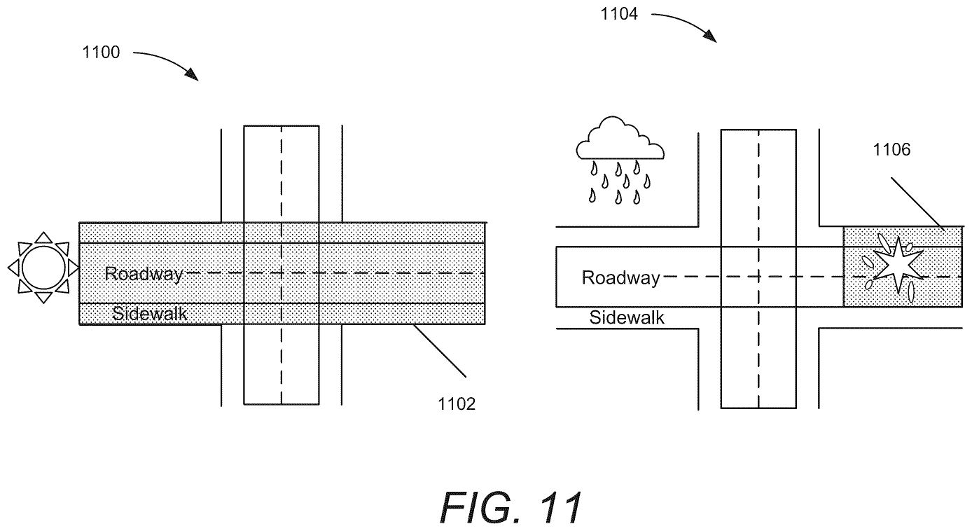

FIG. 11 shows other examples of risky areas, according to aspects of the disclosure. In scenario 1100, the area 1102 has been designated as an area of risk based on the position of the sun at a given time of day. In scenario 1104, area 1106 has been designated as an area of risk having a high accident risk based on weather conditions.

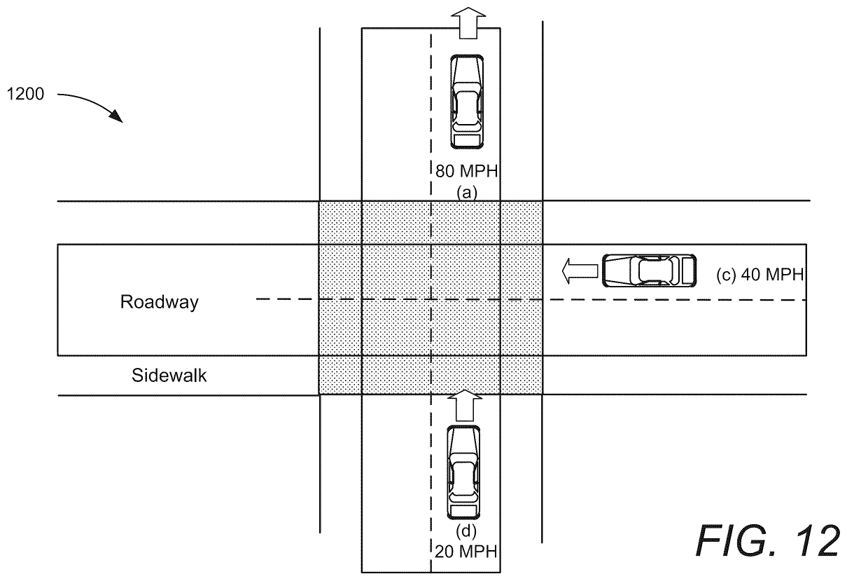

FIG. 12 illustrates an example scenario 1200 in which objects may be prioritized, according to aspects of the disclosure. In FIG. 12, a prioritization of the objects by utility functions would result in an object prioritization of: (a)>(c)>(b). Object prioritization based on DRA criterion would result in an object prioritization of: (a)>(b)>(c). Object prioritization based on TRA would result in an object prioritization of: (c)>(b)>(a). Object prioritization based on TTC would result in an object prioritization of: (c)=(b)>(a). Object prioritization based on DRA, TRA, and TTC ensures that more urgent/important objects are selected for messaging is determined by the particular prioritization mechanism.

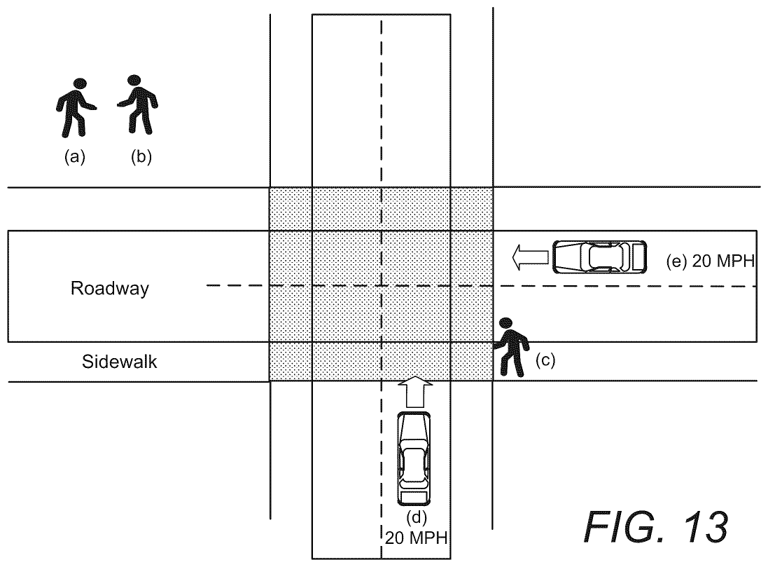

FIG. 13 illustrates another example scenario 1300 in which objects may be prioritized, according to aspects of the disclosure. In FIG. 13, a prioritization of the object by utility functions would result in an object prioritization of: (a)=(b)=(c)>(d)=(e). Object prioritization based on DRA criterion would result in an object prioritization of: (c)>(d)>(e)>(b)>(a). Object prioritization based on TRA criterion would result in an object prioritization of: (c)>(d)>(e)>(a)=(b). Object prioritization based on TTC would result in an object prioritization of: (c)=(d)>(e)>(a)=(b).

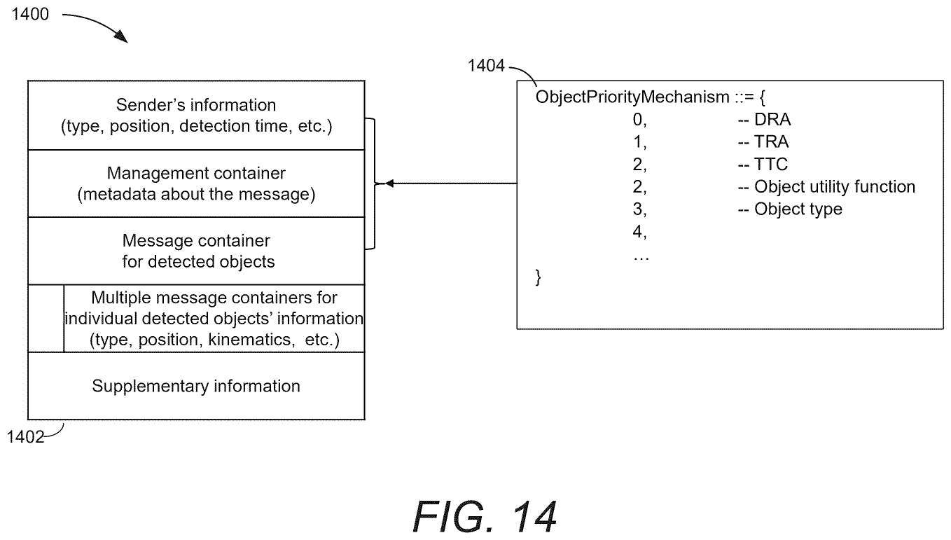

In accordance with various aspects of the disclosure, the object prioritization mechanism and the assessment may be signaled (e.g., indicated in at least part of a message) to another device in the sensing network. FIG. 14 shows an example of a sensor-sharing message structure 1400, according to aspects of the disclosure. As shown, the general message structure 1402 may include an object priority mechanism field 1404 indicating the mechanism used to generate the priorities of the objects identified in the general message structure 1402. In an aspect, this kind of field can be added to any sensor sharing message structure. In an aspect, it may be appropriate to place such a field at a higher level within the general message structure 1402 than within the individual detected objects' container.

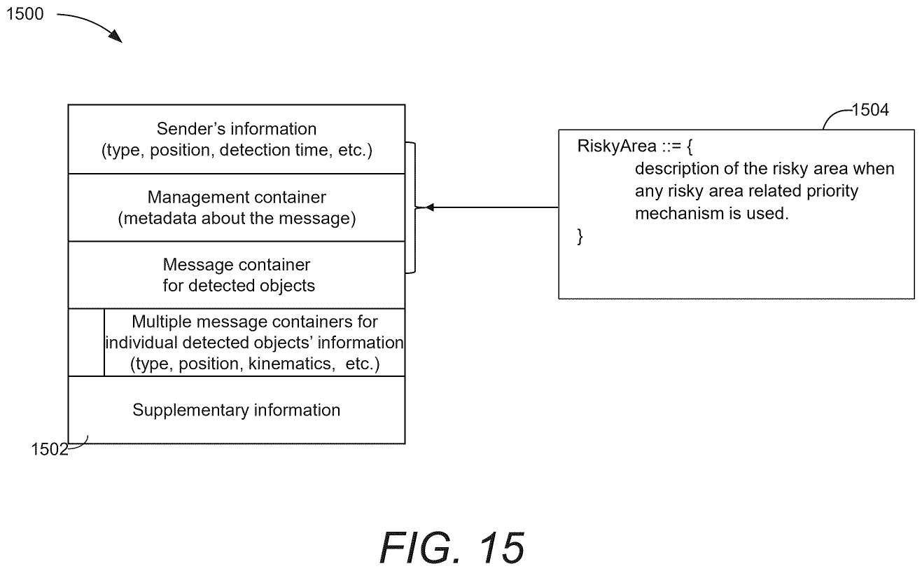

FIG. 15 shows an example of a sensor-sharing message structure 1500, according to aspects of the disclosure. As shown, the general message structure 1502 may include a risky area field 1504 that provides a description of the risky area when any risky area related object prioritization mechanism is used. In an aspect, the risky area field 1504 can be added to any sensor-sharing message structure. In an aspect, it may be appropriate place the risky area field 1504 at a higher level within the general message structure 1502 than the individual detected objects' container along with the message field indicating the ObjectPriorityMechanism.

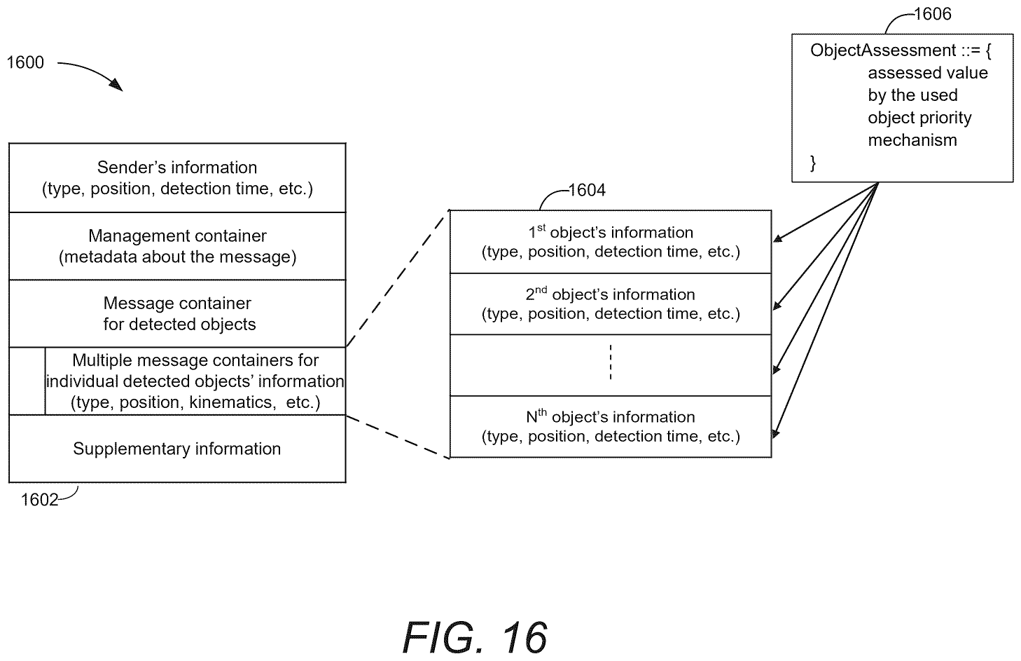

FIG. 16 shows an example of a sensor-sharing message structure 1600, according to aspects of the disclosure. Here, the general message structure 1602 includes multiple message containers 1604 for the detected objects. The message containers may include information relating to each detected object (e.g., object type, position, kinematics, etc.). Here, the multiple message containers 1604 each include an ObjectAssessment field 1606 indicating the assessed prioritization value based on the identified object priority mechanism. In an aspect, the assessment value may provide more information (e.g., regarding the assessed risk) than just the relative priority order, and can have its own specific meaning based on the object priority mechanism (e.g., distance/time to risky area, dynamics, etc.)

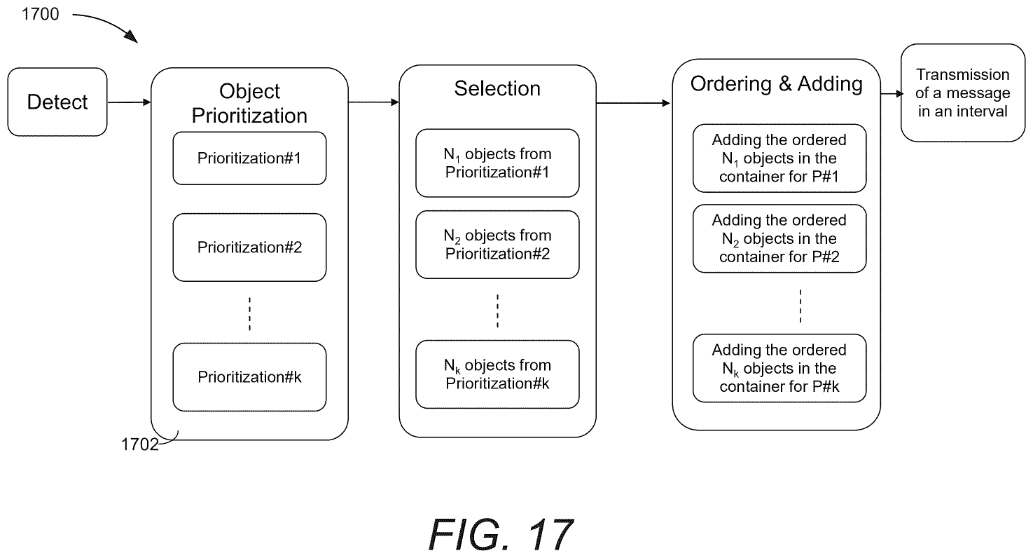

FIG. 17 shows example operations 1700 that may be undertaken to generate and transmit a sensing message, according to aspects of the disclosure. In this example, multiple/different prioritizations can be applied at the same time at the object prioritization operation 1702. For example, Prioritization #1 may be based on TRA criterion, Prioritization #2 may be based on the object utility function, Prioritization #3 may be based on object type, etc.

At the selection operation 1704, the maximum number of objects (e.g., N) has already been determined based on the messaging protocols, network congestion situation and/or the limitation of implementation (denoted by N in this example). N1, N2, . . . , and Nk can be flexibly determined under the condition of N=N1+N2+ . . . +Nk. N1, N2, . . . , and Nk can be fixed or varied over multiple transmissions.

At the ordering and adding operation 1706, the objects are selected based on a naturally ordered prioritization of the objects as determined during the object prioritization operation 1702. The selected objects are added by prioritization into a container when they are to be included in a sensor sharing message. To this end, the priority of a selected object is indicated in the sensor sharing message and therefore known by the receiver. In an aspect, the containers are ordered from Prioritization #1 to Prioritization #k and added in the sensor sharing message. In some scenarios, if the number of detected objects is not too large (e.g., the number of detected objects is below a threshold number), then the employment of multiple prioritizations may be skipped.

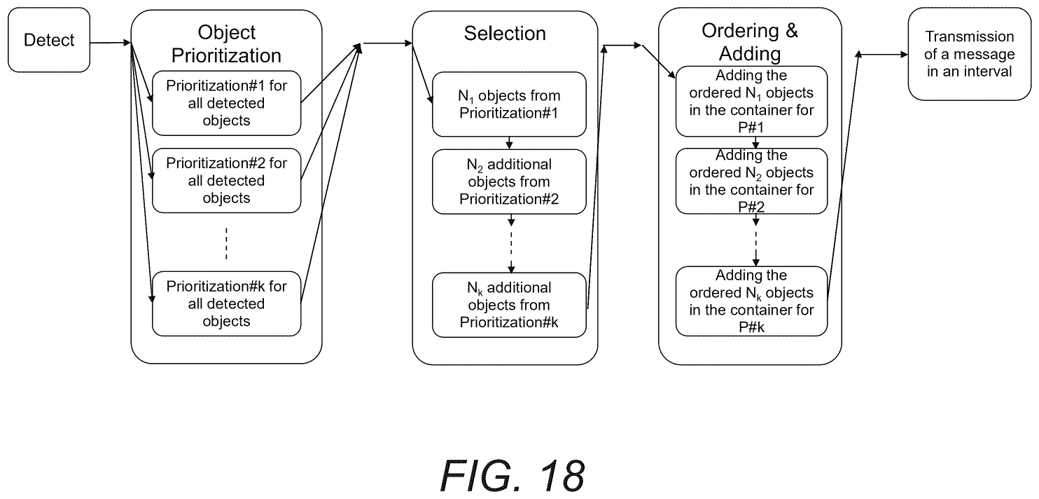

FIG. 18 through FIG. 21 show variations of the example operations that may be undertaken to generate and transmit a sensing message, according to aspects of the disclosure. In FIG. 18, multiple prioritization mechanisms are applied to all of the detected objects and subsequently processed as such.

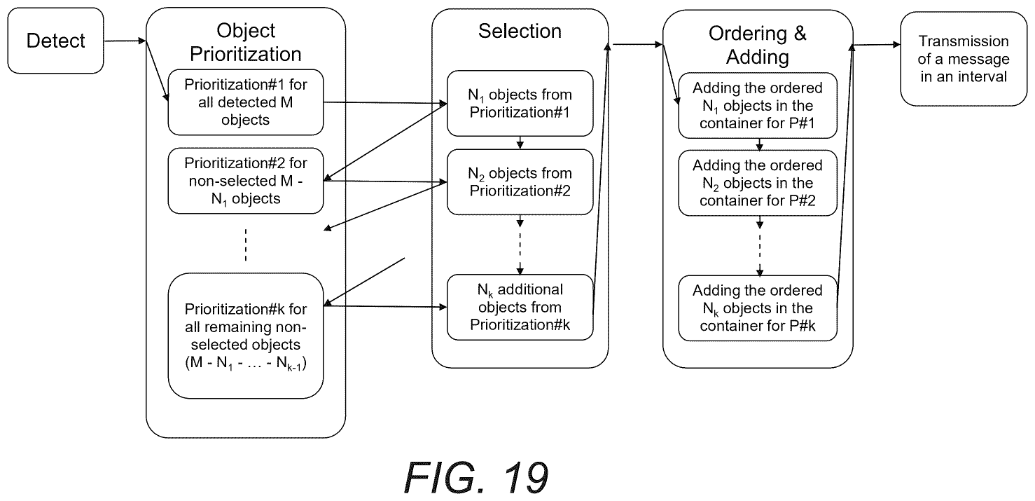

In FIG. 19, multiple prioritization mechanisms are also used. However, the objects to which a particular prioritization mechanism is applied varies from prioritization mechanism to prioritization mechanism, where the objects subject to a particular prioritization mechanism are determined based on the selection operations.

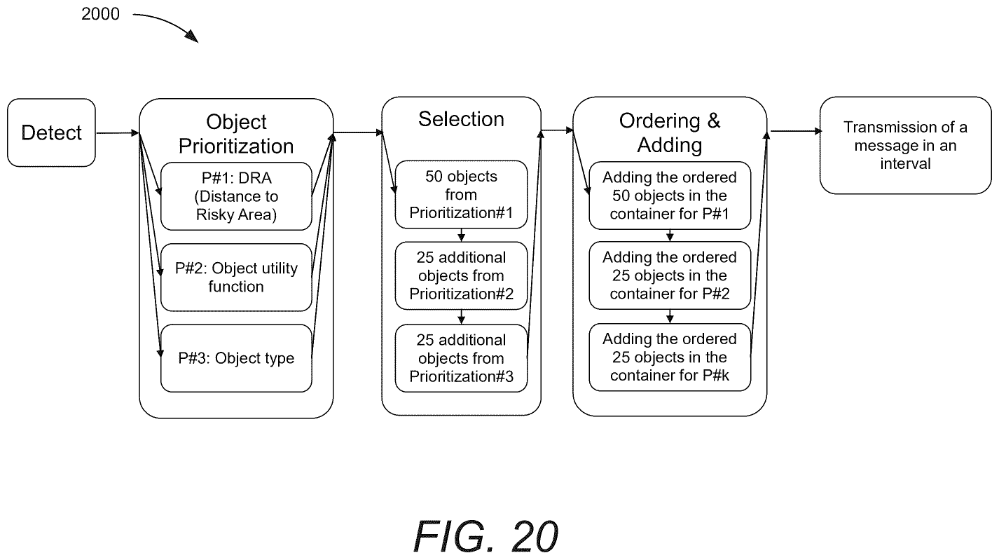

In FIG. 20, multiple prioritization mechanisms are used. However, the number of objects selected during the selection operation is based on the prioritization mechanism used to prioritize the object. As shown, fifty objects are selected from the objects that have been prioritized using the Prioritization #1 mechanism. In this example, twenty-five additional objects are selected from the objects that have been prioritized using the Prioritization #2 mechanism. Still further, twenty-five additional objects are selected from the objects that have been prioritized using the Prioritization #3 mechanism.

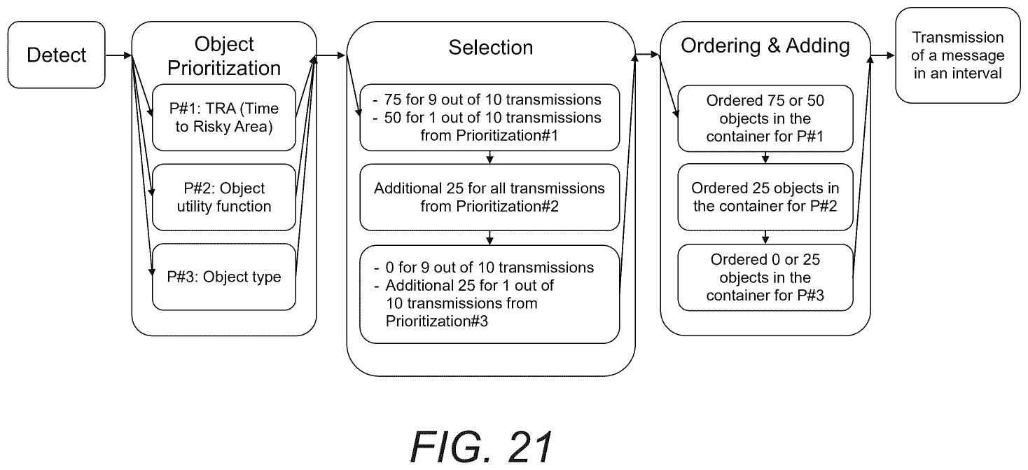

In FIG. 21, the number of selected objects is also based on the prioritization mechanism that is used to prioritize the objects. However, the number of transmissions using a particular number of objects that have been prioritized using a given prioritization mechanism varies from transmission-to-transmission.

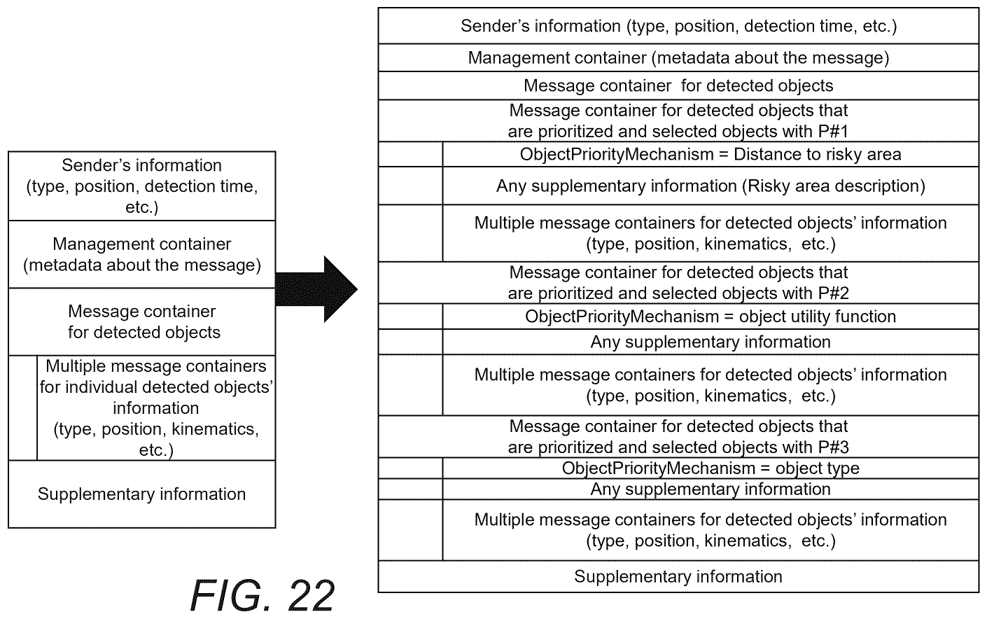

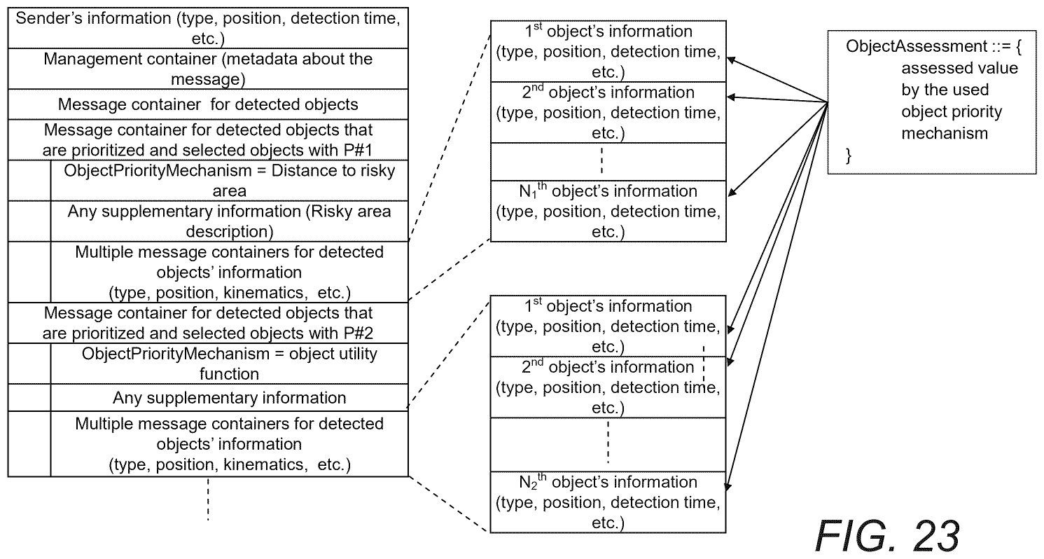

FIG. 22 and FIG. 23 show example sensor-sharing message structures, according to aspects of the disclosure. In each sensor-sharing, the sensor-sharing message structure includes an arrangement of fields that organize objects based on the prioritization mechanism used to prioritize the object. However, the particular manner in which the message structure indicates the object and the prioritization mechanism used to prioritize the object in FIG. 22 is different the particular manner in which the message structure indicates the object and the prioritization mechanism used to prioritize the object in FIG. 23.

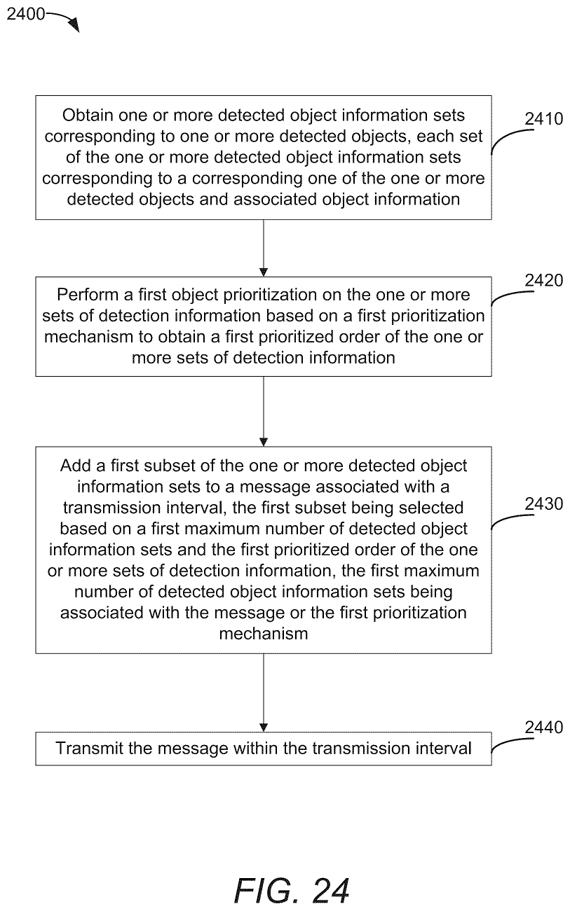

FIG. 24 illustrates an example method 2400 of wireless communication, according to aspects of the disclosure. In some aspects, method 2400 may be performed by a processing device (e.g., any of the processing device, UEs, or RSUs described herein). In some aspects, method 2400 may be performed by the processing device 300 as illustrated in FIG. 3.

At 2410, the processing device may obtain one or more detected object information sets corresponding to one or more detected objects, each set of the one or more detected object information sets corresponding to a corresponding one of the one or more detected objects and associated object information. In an aspect, operation 2410 may be performed by the one or more WWAN transceivers 310, the one or more short-range wireless transceivers 320, the one or more processors 342, memory 340, and/or sensor sharing component 348, any or all of which may be considered means for performing this operation.

At 2420, the processing device may perform a first object prioritization on the one or more sets of detection information based on a first prioritization mechanism to obtain a first prioritized order of the one or more sets of detection information. In an aspect, operation 2420 may be performed by the one or more WWAN transceivers 310, the one or more short-range wireless transceivers 320, the one or more processors 342, memory 340, and/or sensor sharing component 348, any or all of which may be considered means for performing this operation.

At 2430, the processing device may add a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism. In an aspect, operation 2430 may be performed by the one or more WWAN transceivers 310, the one or more short-range wireless transceivers 320, the one or more processors 342, memory 340, and/or sensor sharing component 348, any or all of which may be considered means for performing this operation.

At 2440, the processing device may transmit the message within the transmission interval. In an aspect, operation 2440 may be performed by the one or more WWAN transceivers 310, the one or more short-range wireless transceivers 320, the one or more processors 342, memory 340, and/or sensor sharing component 348, any or all of which may be considered means for performing this operation.

As will be appreciated, a technical advantage of the method 2400 is that it prioritizes the detected objects in a manner that limits the number of the detected object information sets that are to be transmitted during a transmission interval. In an aspect, the objects are prioritized for inclusion in the detected object information sets using different prioritization mechanisms in order to timely provide critical information to other vehicles or pedestrians without overly burdening the resources for transmission of safety services related messages.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a processing device, the method comprising:
obtaining one or more detected object information sets corresponding to one or more detected objects, each set of the one or more detected object information sets corresponding to a corresponding one of the one or more detected objects and associated object information;
performing a first object prioritization on the one or more sets of detection information based on a first prioritization mechanism to obtain a first prioritized order of the one or more sets of detection information;
adding a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and
transmitting the message within the transmission interval.

2. A processing device, comprising:
one or more memories;
one or more transceivers; and
one or more processors communicatively coupled to the one or more memories and the one or more transceivers, the one or more processors, either alone or in combination, configured to:
obtain one or more detected object information sets corresponding to one or more detected objects, each set of the one or more detected object information sets corresponding to a corresponding one of the one or more detected objects and associated object information;
perform a first object prioritization on the one or more sets of detection information based on a first prioritization mechanism to obtain a first prioritized order of the one or more sets of detection information;
add a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and
transmit, via the one or more transceivers, the message within the transmission interval.

3. The processing device of claim 2, wherein the one or more processors, either alone or in combination, are configured to be free from transmitting, within the transmission interval, another message that includes any of the one or more detected object information sets.

4. The processing device of claim 2, wherein the one or more processors, either alone or in combination, are further configured to:
obtain the first maximum number of detected object information sets that is associated with the message based on a communication protocol, a network congestion status, a processing capability of the processing device, a communication capacity over which the message is transmitted, or any combination thereof.

5. The processing device of claim 2, wherein the first prioritization mechanism comprises:
a distance to risky area (DRA) mechanism;
a first time to risky area (TRA) mechanism based on a detected object heading and a detected object speed;
a second TRA mechanism based on the detected object heading, the detected object speed, and a detected object acceleration rate; or
a time to collision (TTC) mechanism.

6. The processing device of claim 5, wherein a risky area assessed by the DRA mechanism, the first TRA mechanism, or the second TRA mechanism is determined based on:
historical crash data;
a work zone;
a hidden area;
a road pavement condition;
a time period associated with a sun glare condition;
an increased risk associated with a weather condition; or
any combination thereof.

7. The processing device of claim 2, wherein the message comprises:
a first data field storing a prioritization indication indicating the first prioritization mechanism;
a second data field including one or more detected object containers storing respective set of the first subset of the one or more detected object information sets; or
both.

8. The processing device of claim 7, wherein the message comprises:
a sender's information container storing sender's information;
a management container storing metadata of the message; and
a message container including the second data field, and
wherein the first data field is included in the sender's information container, the management container, or the message container.

9. The processing device of claim 8, wherein the sender's information indicates:
a type of the processing device;
a position of the processing device;
a detection time of the one or more detected object information sets; or
any combination thereof.

10. The processing device of claim 7, wherein the message comprises:
a third data field storing a risky area indication indicating a risky area assessed by the first prioritization mechanism;
a sender's information container storing sender's information;
a management container storing metadata of the message; and
a message container including the second data field,
wherein the first data field is included in the sender's information container, the management container, or the message container, and
wherein the third data field is included in the sender's information container, the management container, or the message container.

11. The processing device of claim 2, wherein each set of the first subset of the one or more detected object information sets included in the message indicates:
a detected type of the corresponding detected object;
a detected position of the corresponding detected object;
one or more detected kinematics characteristics of the corresponding detected object;
a detection time of the corresponding set of the first subset of the one or more detected object information sets; or
any combination thereof.

12. The processing device of claim 2, wherein the one or more processors, either alone or in combination, are further configured to:
perform a plurality of object prioritization, including the first object prioritization, on the one or more sets of detection information based on a plurality of prioritization mechanisms, including the first prioritization mechanism, to obtain a plurality of prioritized orders, including the first prioritized order, of the one or more sets of detection information; and
sequentially select a plurality of subsets of the one or more detected object information sets, including the first subset of the one or more detected object information sets, to be added to the message associated with the transmission interval, each one of the plurality of subsets being selected based on a respective maximum number of detected object information sets and the respective prioritized order of the one or more sets of detection information of the corresponding one of the plurality of prioritization mechanisms from not-yet-selected ones of the one or more detected object information sets, the respective maximum number of detected object information sets being associated with the corresponding one of the plurality of prioritization mechanisms.

13. The processing device of claim 12, wherein a summation of the maximum numbers of detected object information sets associated with the plurality of prioritization mechanisms equals a maximum number of detected object information sets that is associated with the message.

14. The processing device of claim 12, wherein the message comprises:
a plurality of message containers, each one of the plurality of message containers including a data field that stores a corresponding one of the plurality of subsets of the one or more detected object information sets.

15. The processing device of claim 14, wherein each one of the plurality of message containers includes another data field that stores corresponding supplemental information regarding a corresponding one of the plurality of prioritization mechanisms associated with the corresponding one of the plurality of subsets of the one or more detected object information sets.

16. The processing device of claim 15, wherein the corresponding supplemental information includes one or more parameters of the corresponding one of the plurality of subsets of the one or more detected object information sets assessed by the corresponding one of the plurality of prioritization mechanisms.

17. The processing device of claim 2, wherein the one or more processors, either alone or in combination, are further configured to:
sequentially perform a combination of two operations on not-yet-selected ones of the one or more detected object information sets, the two operations comprising:
performing of a current object prioritization on the not-yet-selected ones of the one or more sets of detection information based on a current one of a plurality of prioritization mechanisms, including the first prioritization mechanism, to obtain a current prioritized order of the not-yet-selected ones of the one or more sets of detection information; and
selecting of a current subset of the one or more detected object information sets, from the not-yet-selected ones of the one or more detected object information sets, to be added to the message associated with the transmission interval, the current subset being selected based on a current maximum number of detected object information sets associated with the current one of the plurality of prioritization mechanisms and the current prioritized order of the not-yet-selected ones of the one or more sets of detection information.

18. The processing device of claim 17, wherein a summation of the maximum numbers of detected object information sets associated with the plurality of prioritization mechanisms equals a maximum number of detected object information sets that is associated with the message.

19. The processing device of claim 17, wherein the message comprises:
a plurality of message containers, each one of the plurality of message containers including a data field that stores a corresponding subset of the one or more detected object information sets.

20. A processing device, comprising:
means for obtaining one or more detected object information sets corresponding to one or more detected objects, each set of the one or more detected object information sets corresponding to a corresponding one of the one or more detected objects and associated object information;
means for performing a first object prioritization on the one or more sets of detection information based on a first prioritization mechanism to obtain a first prioritized order of the one or more sets of detection information;
means for adding a first subset of the one or more detected object information sets to a message associated with a transmission interval, the first subset being selected based on a first maximum number of detected object information sets and the first prioritized order of the one or more sets of detection information, the first maximum number of detected object information sets being associated with the message or the first prioritization mechanism; and
means for transmitting the message within the transmission interval.
